(19) United States
(12) Patent Application Publication
(10) Pub. No.: US 2013/0048928 A1
(43) Pub. Date: Feb. 28, 2013

(54) POST EXTRACTOR AND METHODS THEREOF

(71) Applicant: Jerry Bitner, Round Rock, TX (US)

(72) Inventor: Jerry Bitner, Round Rock, TX (US)

(21) Appl. No.: 13/219,976

(22) Filed: Aug. 29, 2011

(51) Int. Cl. E04H 17/26; B66F 3/08

(52) U.S. Cl. 254/231; 254/199

(57) ABSTRACT

Extracting apparatuses of the present disclosure include post extracting apparatus comprising a housing having a bore therethrough, wherein the bore includes a shoulder. A lift member is adapted to receive an attachment member at a first end of the lift member. The lift member is disposed in the bore and is operatively associated with an actuator. The actuator engages with at least a portion of the shoulder. Actuation of the actuator causes the lift member and the attachment member to move in a first direction.

### CROSS-REFERENCE TO RELATED APPLICATION

None

### FIELD OF THE DISCLOSURE

The present disclosure relates generally to an extractor and methods thereof. In particular, the present disclosure relates to an extracting apparatus for removing a buried fence post from the ground and methods thereof.

### BACKGROUND

Prior fence systems are generally known. One such illustrative fence system is the post and rail fence. In an embodiment, a post and rail fence may be constructed by inserting posts into dug-out holes in the ground. The posts may be inserted into the dug-out holes such that they are vertical, or otherwise generally perpendicular to the ground. The inserted posts may be secured in place by being buried in dirt, casted in cement, or a combination thereof. Preferably, the posts are buried to a depth sufficient to provide rigidity and strength. Rails may be affixed to adjacent posts along the horizontal, or otherwise generally parallel to the ground. The posts and rails may be independently formed of materials such as wood or metal.

Over time, it may be desirable to remove, or replace the posts of the fence due to wood rot, metal corrosion, aesthetic desirability, and the like. One past system of removing or replacing the posts may be digging out the earth around them until they can be pulled up or removed by hand.

### SUMMARY OF THE DISCLOSURE

Broadly, the disclosure herein is directed to extracting apparatuses and methods thereof. In one embodiment, an exemplary extracting apparatus may be a post extracting apparatus that may comprise: a housing having a bore therethrough, wherein the bore may include a shoulder. A lift member may be adapted to receive an attachment member at a first end of the lift member. The lift member may be disposed in the bore and may be operatively associated with an actuator. The actuator may engage with at least a portion of the shoulder. Actuation of the actuator may cause the lift member and the attachment member to move in a first direction.

In an alternative embodiment, an exemplary extracting apparatus may be a post extracting apparatus that may comprise: a housing having a bore therethrough, wherein the bore may have a shoulder. A lift member may be adapted to receive an attachment member at a first end of the lift member. The lift member may be disposed in the bore and operatively associated with an actuator. The actuator may be operatively associated with a pivot member disposed between the actuator and the housing. The pivot member may be engaged with at least a portion of the shoulder. Actuation of the actuator may cause the lift member and the attachment member to move in a first direction.

In a still further alternative embodiment, a method of removing a buried post from a buried position is disclosed herein. The method may comprise providing proximate to the buried post a post extracting apparatus as disclosed in either of the two preceding paragraphs. The method may further include securing the attachment member of the post extracting apparatus to the buried post. The method may further include utilizing the actuator of the post extracting apparatus to move the lift member post extracting apparatus, attachment member post extracting apparatus, and buried post in at least a first direction a distance sufficient to remove the buried post from the buried position.

While extracting apparatuses and methods thereof will be described in connection with various preferred illustrative embodiments, it will be understood that it is not intended to limit the extracting apparatuses and methods thereof to those embodiments. On the contrary, it is intended to cover all alternatives, modifications, and equivalents as may be included within the spirit and scope of the invention as defined by the appended claims.

### BRIEF DESCRIPTION OF THE DRAWING FIGURES

The present extracting apparatus and method of using an extracting apparatus may be understood by reference to the following description taken in conjunction with the accompanying drawing figures, which are not to scale and contain certain aspects in exaggerated or schematic form in the interest of clarity and conciseness, wherein the same reference numerals are used throughout this description and in the drawing for components having the same structure, and primed or lettered reference numerals are used for components having a similar function and construction to those elements bearing the same unprimed or unlettered reference numerals, and wherein:

FIG. 1 is a side view of an extracting apparatus according to an illustrative embodiment of the present disclosure;

FIG. 2 is a side view of an alternative extracting apparatus according to an alternative illustrative embodiment of the present disclosure;

FIG. 3 is a perspective view of the extracting apparatus according to the illustrative embodiment of the extracting apparatus of FIG. 2 having a first attachment member, wherein the first attachment member is engaged with a buried post prior to actuation of the actuator;

FIG. 4 is a perspective view of the extracting apparatus according to the illustrative embodiment of the extracting apparatus of FIG. 2 having the first attachment member illustrated in FIG. 3, wherein the first attachment member is engaged with the buried post during actuation of the actuator;

FIG. 5 is a perspective view of the extracting apparatus according to the illustrative embodiment of the extracting apparatus of FIG. 2 having a second attachment member, wherein the second attachment member is engaged with a buried post prior to actuation of the actuator;

FIG. 6 is a perspective view of the extracting apparatus according to the illustrative embodiment of the extracting apparatus of FIG. 2 having the second attachment member illustrated in FIG. 5, wherein the second attachment member is engaged with the buried post during actuation of the actuator; and

FIG. 7 is a perspective view of an extracting apparatus according to the illustrative embodiment of the extracting apparatus of FIG. 2 having a third attachment member, wherein the third attachment member is engaged with an intact buried post during actuation of the actuator.

### DETAILED DESCRIPTION OF THE EMBODIMENT

Although explanatory embodiments have been shown and described, it would be appreciated by those skilled in the art that changes, alternatives, and modifications all falling into the scope of the appended claims and their equivalents can be made in the embodiments without departing from spirit and principles of the disclosure.

With reference to the drawing figures, in one particular embodiment, a post extracting apparatus 100, 100′ may comprise: a housing 105 having a bore 110, which may include a shoulder 115; a lift member 120; an attachment member 125; and an actuator 130, 130′. The lift member 120 may be disposed in the bore 110 and may be operatively associated with an actuator 130. The actuator 130, 130′ may be engaged with at least a portion of the shoulder 115. The attachment member 125 may be associated with, received by, or otherwise in engagement with a first, or lower, end or connection 135 of the lift member 120. In an embodiment, actuation of the actuator 130 may cause the lift member 120 and the attachment member 125 to move in a first direction, optionally D. In an embodiment, the first direction, D, may be opposite of the direction in which a post 200, 200′, optionally a fence post, was previously buried, or otherwise inserted or anchored, into a surface such as the ground. Alternatively, the first direction, D, may be generally opposite the normal, or average, gravitational pull by the earth on an object such as the post 200, 200′.

The housing 105 may be formed of any suitable material having the requisite strength and durability to support actuation of the actuator during use (detailed further below), including hardened wood, plastic, metal, metal alloys, and combinations thereof. In an embodiment, the housing 105 may be of any shape and size suitable to form the bore 110 through which the lift member 120 may be disposed, provide the shoulder 115 against which the actuator 130 may be actuated, and provide at least some clearance between the attachment member 125 and the object or post 200, 200′ to be extracted, or removed. In an embodiment, the housing 105 may have a body 140 having at least two, optionally at least three legs 145A and 145B (the third leg is not shown) affixed thereto. The body 140, however, may be formed of any geometric cross-sectional shape, including triangular, circular (as shown), rectangular, pentagonal, etc. In an embodiment, the at least three legs 145A and 145B (the third leg is not shown) may be removablely affixed to the tubular body 140 by pins, slots, or bolts. Alternatively, the at least three legs 145A and 145B (the third leg is not shown) may be permanently affixed to the tubular body 140 by, for example, being formed integral or welded thereto. In still further embodiments, at least two, optionally at least three, leg extensions 150A, 150B, 150C may be removablely affixed to respective legs 145A and 145B (the third leg is not shown) by pins, slots, or bolts 155A and 155B (the third bolt is not shown). Alternatively, at least two, optionally at least three, leg extensions 150A, 150B, 150C may be permanently affixed to respective legs 145A and 145B (the third leg is not shown) by, for example, being formed integral or welded thereto. Braces, rails, or chains 147A, 147B, 147C, may be affixed to respective legs 145A and 145B (the third leg is not shown) or leg extensions 150A, 150B, 150C to add stability and rigidity to the extracting apparatus 100, 100′. In a still further embodiment, at least two, optionally at least three, feet, pads, or supports 160A, 160B, 160C, may be removablely affixed to respective legs 145A and 145B (the third leg is not shown), or to respective leg extensions 150A, 150B, 150C, by pins, slots, or bolts. Alternatively, the at least two, optionally at least three, feet, pads, or supports 160A, 160B, 160C, may be permanently affixed to respective legs 145A and 145B (the third leg is not shown), or to respective leg extensions 150A, 150B, 150C, by, for example, being formed integral or welded thereto.

The lift member 120 may be any structure having the requisite strength and rigidity under tension to withstand the force, optionally tensile force, necessary to remove a buried object, such as a buried fence post from the ground, upon actuation of the actuator 130. Without limitation, the lift member 120 may be a rod formed of metal or metal alloy such as steel, stainless steel, aluminum alloys, and combinations thereof. The rod may be formed of any geometric cross-sectional shape, including triangular, circular (as shown), rectangular, pentagonal, etc. In an embodiment, the lift member 120 may be at least as long as—alternatively at least 5, 10, 15, 20, 25, 30, 45, 40, 50 percent longer than—the length desired to lift, or otherwise move, the attachment member along the first direction, D, in order to remove a buried object, such as a buried fence post, from the ground. Optionally, the lift member 120 may include threading or teeth for reciprocal engagement of the actuator 130, 130′ (described further below).

The attachment member 125 may be any structure that may secure, or otherwise affixed, itself at a first end on or to the lift member 120 and at a distal end on or to the buried object (such as a buried fence post 200, 200′) with enough bite, grip, or force necessary to remove a buried object, such as a buried fence post 200, 200′ from the ground, upon actuation of the actuator. Without limitation, the attachment member 125 may have at its first end an attachment member connection or clevis 165, which may receive or be received by a cooperating lift member end or lift member connection 135 of the lift member 120. In an embodiment, the clevis 165 may be any piece, or pieces, suitable for affixing or securing the first end of the attachment member 125 to the lift member 120. For example, the clevis 165 may include a chain affixed to a fitting having female threads adapted to be received by the threaded lift member 120, or a chain affixed to a fitting having external male threads, a snap connection, a hook, or a pin adapted to be received by a cooperateable end of the lift member 120. Without limitation, the attachment member 125 may have affixed to its distal end a tool 170 that may secure, or otherwise itself to the buried object (such as a buried fence post). The tool 170 may be a clamp, a lag bolt 170′, a wire rope 170″, a chain with a grab hook 170″′, or a screw formed of any material including metal or metal alloy such as steel, stainless steel, aluminum alloys, and combinations thereof. In an embodiment, the tool 170 may be lag bolt 170′ or a screw and may be inserted or screwed into the fence post at any angle, A. Optionally, a hole may be bored into the fence post and the tool 170 may be a lag bolt 170′ or a screw and may be inserted or screwed into the hole. Without wishing to be limited by the theory, Applicant believes that inserting or screwing the tool into the fence post at an angle, A, ranging from between about 1 degree to about 10 degrees, alternatively between about 2 degrees and 5 degrees, off of the vertical may make extraction of the object to be extracted, such as a buried fence post, easier by breaking the “suction” between the plug and the ground.

The actuator 130, 130′ may be any structure having the requisite strength and rigidity under tension to withstand the force necessary to remove a buried object, such as a buried fence post from the ground. Without limitation, the actuator 130, 130′ may be formed of metal or metal alloy such as steel, stainless steel, aluminum alloys, and combinations thereof. The actuator 130, 130′ may further be any structure capable of moving or lifting the lift member 120.

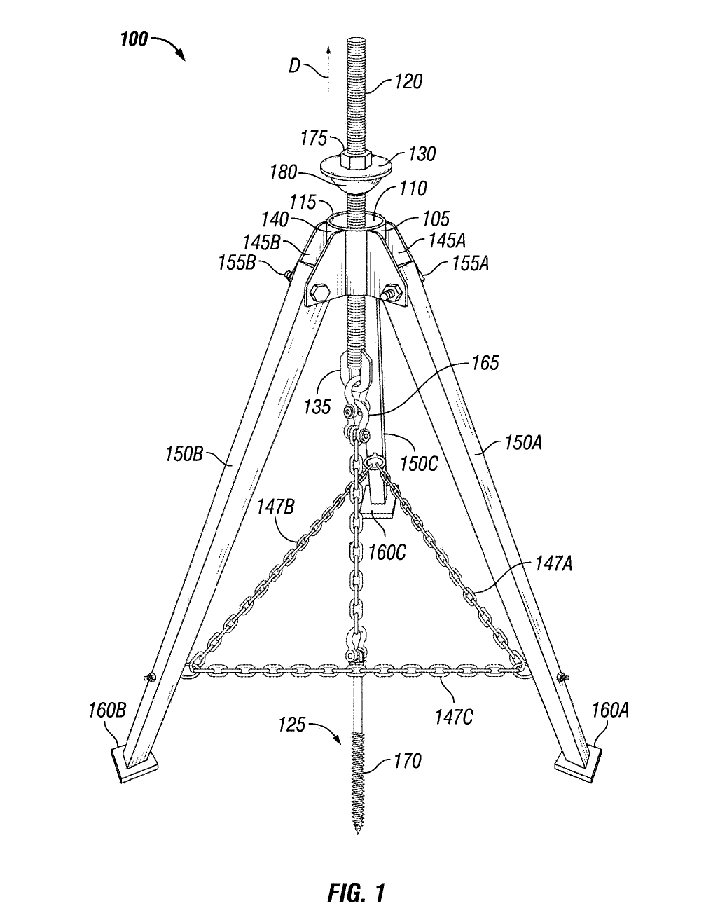

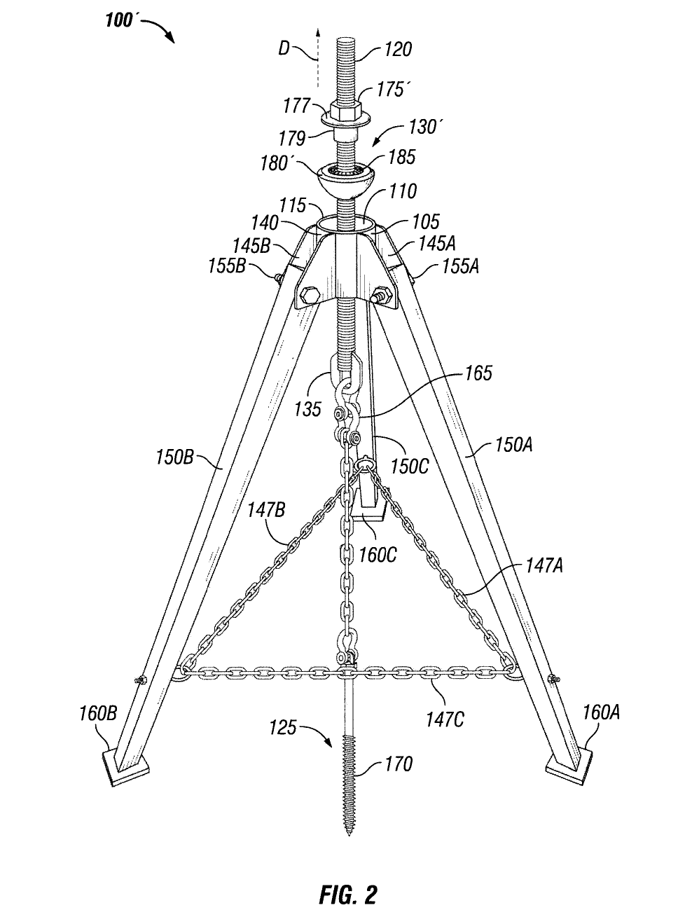

In an embodiment, the actuator 130 may include an engagement portion 175, 175′ and a pivot portion 180, 180′. The engagement portion 175, 175′ may engage or affix the actuator 130, 130′ to the lift member 120. In an embodiment, the engagement portion 175, 175′ may be an internally threaded nut or coupling 177 having a collar 179 (optionally a tubular collar). The internally threaded nut or coupling 177 may be cooperatively received by the lift member 120 having reciprocal threads. In an embodiment, the collar 179 may be disposed or fitted within a bore of the pivot member 180′ (described below) and may prevent the bearing 185 from fouling (or getting stuck) in the threads of the lift member 120. Alternatively, the engagement portion 175, 175′ may be a ratchet, which is cooperatively received by the lift member 120 having reciprocal teeth or gears. Thus, in the embodiment, the actuator 130, 130′ may be moved along a length of the lift member 120. The pivot portion 180, 180′ may be formed integral with the engagement portion 175 (as illustrated in FIG. 1) or may be separate from the engagement portion 175′ (as illustrated in FIG. 2). In an embodiment, actuation of the engagement portion 175, 175′ may force the pivot portion 180, 180′ to push against the shoulder 115 of the housing 105, and move or lift the lift member 120 disposed in the bore 110 of the housing 105 in an opposing direction, D. Without wishing to be bound by the theory, Applicant believes that if the pivot portion 180, 180′ is rounded or generally curved, it may float or move against the shoulder 115 of the housing 105 and generally self-center the lift member 120 vertically within the bore 110, which may optionally keep lift member 120 generally parallel to the plane of the buried post 200. In an alternative embodiment, a flat bearing 185 may be disposed between the engagement member 175′ and the pivot portion 180′. Alternatively, the flat bearing 185 may be disposed between the internally threaded nut or coupling 177 of the engagement member 175′ and the pivot portion 180′. Without wishing to be bound by the theory, Applicant believes that the flat bearing 185 may reduce the friction between the engagement member 175′ and the pivot member 180′ and improve centering of the lift member 120 during actuation of the actuator when the tool 170 is engaged with a post 200, 200′.

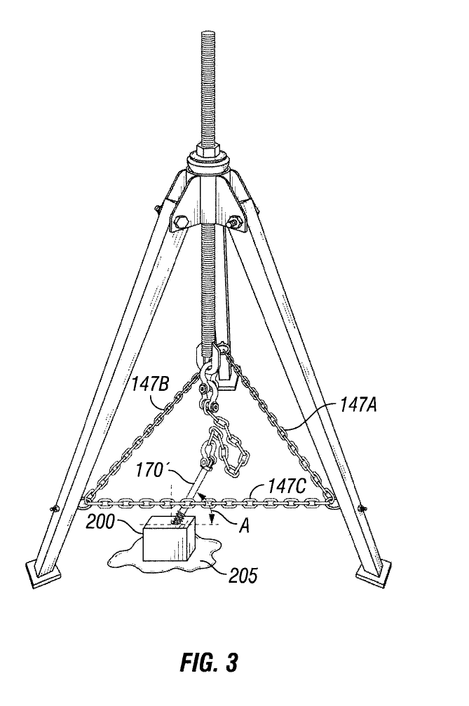

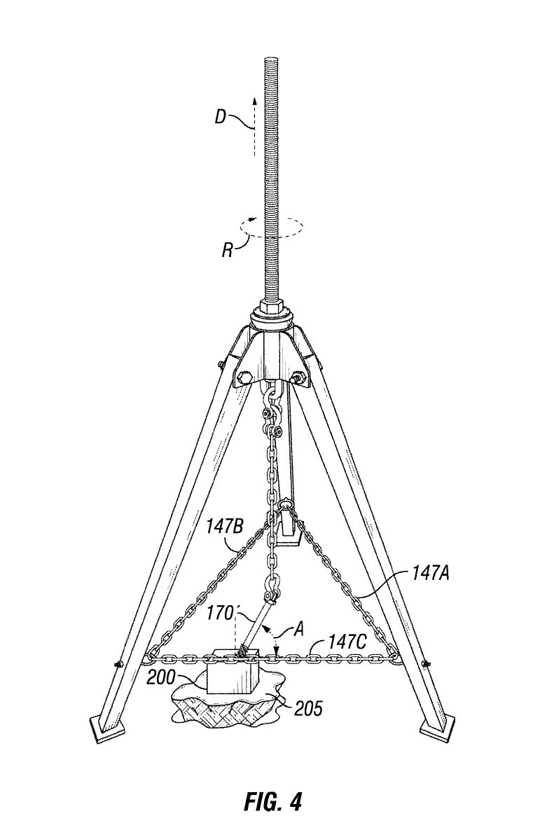

With respect to FIGS. 3 and 4, an embodiment of a method of removing a buried post 200 from a buried position may be schematically illustrated. The method may include providing proximate to the buried post 200 the post extracting apparatus 100′, as described above. The method may further include securing the tool, which may be a lag bolt 170′ of the attachment member 125 (optionally at an angle, A, as described above) to the buried post 200. In an embodiment, the lag bolt 170′ may be secured to the buried post 200 by any suitable methods including screwing or nailing. After the lag bolt 170′ is secured to the buried post 200 as illustrated in FIG. 3, the actuator 130′ may be actuated. In an embodiment, the actuator 130′ may be actuated by rotating the engagement member 175 in or against a rotational direction, R. Any number of suitable instruments, including wrenches, ratchets, wenches, and pulley systems may be used to assist in rotating the engagement member 175′. The rotation of the engagement member 175′ may cause the lift member 120, attachment member 125 and post 200 to lift or move in at least a first direction D (the post 200 may move in other directions as well). Such lift or movement may cause the post 200 to be removed from the ground. Optionally, the lift or movement may cause the post 200 and its respective casing 205 to be removed from the ground. Still further, Applicant believes that the rounded or curved nature of the pivot member 180′ may assist to maintain the lift member 120 in a generally parallel and opposite direction to the direction the post 200 was previously inserted into the ground.

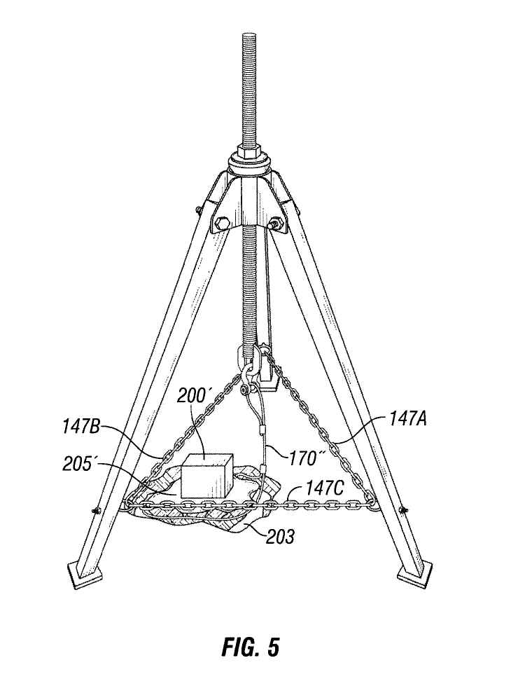

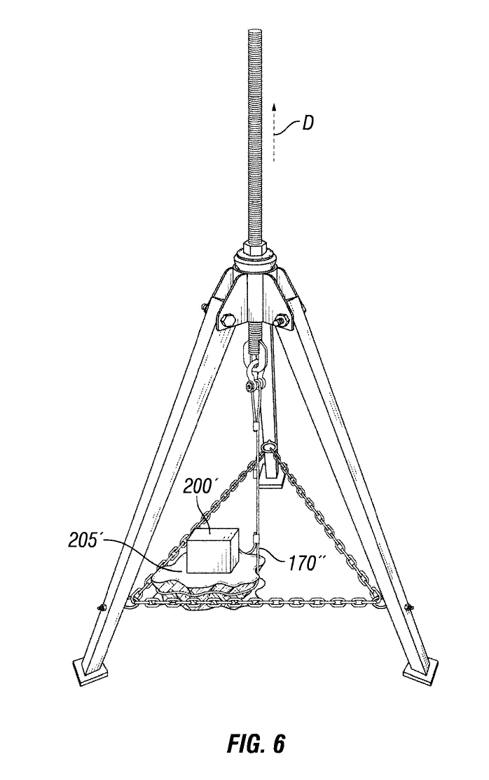

With respect to FIGS. 5 and 6, an alternative embodiment of a method of removing a buried post 200′ from a buried position may be schematically illustrated. The method may include providing proximate to the buried post 200′ the post extracting apparatus 100′, as describe above. The method may optionally include digging a trough 203 around the buried post 200′. The method may further include securing the tool, which may be a wire rope 170″ to or about the buried post 200′, and optionally about the cement casing 205′ housing the buried post 200′. In an embodiment, the wire rope 170″ may be secured to the buried post 200′, and optionally to the cement casing 205′, by any suitable methods including wrapping it thereabout. After the wire rope 170″ is secured to the cement casing 205′ as illustrated in FIG. 5, the actuator 130′ may be actuated. In an embodiment, the actuator 130′ may be actuated by rotating the engagement member 175 in or against a rotational direction, R. Any number of suitable instruments, including wrenches, wenches, ratchets, and pulley systems may be used to assist in rotating the engagement member 175′. The rotation of the engagement member 175′ may cause the lift member 120, attachment member 125 and post 200′ to lift or move in at least a first direction D (the post 200′ may move in other directions as well). Such lift or movement may cause the post 200′ to be removed from the ground. Optionally, the lift or movement may cause the post 200′ and its respective casing 205′ to be removed from the ground. Still further, Applicant believes that the rounded or curved nature of the pivot member 180′ may assist to maintain the lift member 120 in a generally parallel direction relative to the direction the post 200′ was previously inserted into the ground.

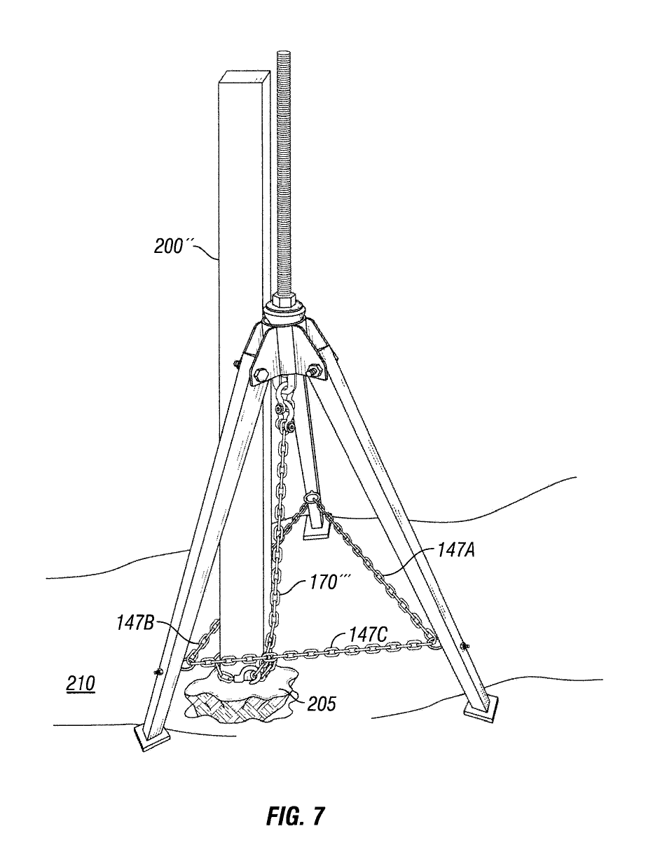

In a still further embodiment with respect to FIG. 7, an extracting apparatus is provided having a chain and hook tool 170″′, which may be utilized to remove an intact buried post 200″. In an embodiment, the chain and hook tool 170″′ may be wrapped or otherwise disposed about the intact buried post 200″ and then the extracting apparatus may be actuated. Alternatively, a trough (not shown) may be dug about the intact buried post 200″, and the chain and hook tool 170″ may be wrapped or otherwise disposed about the casing (not shown) that houses the intact buried post 200″ and then the extracting apparatus may be actuated. In a still further embodiment (not shown), the extracting apparatus may be provided having a wire rope tool 170″, which may be utilized to remove an intact buried post 200″. Optionally, as illustrated in FIG. 7 the ground 210 or floor upon which the extracting apparatuses of the present disclosure may be uneven or otherwise curved.

What is claimed is:

1. A post extracting apparatus comprising:
a housing having a bore therethrough, wherein the bore includes a shoulder;
a lift member adapted to receive an attachment member at a first end of the lift member, the lift member is disposed in the bore and operatively associated with an actuator, the actuator engaged with at least a portion of the shoulder, wherein actuation of the actuator causes the lift member and the attachment member to move in a first direction.

2. A post extracting apparatus comprising:
a housing having a bore therethrough, wherein the bore has a shoulder;
a lift member adapted to receive an attachment member at a first end of the lift member, the lift member is disposed in the bore and operatively associated with an actuator, the actuator is operatively associated with a pivot member that is disposed between the actuator and the housing, the pivot member engaged with at least a portion of the shoulder, wherein actuation of the actuator causes the lift member and the attachment member to move in a first direction.

3. The post extracting apparatus of claim 2 further comprising: a bearing associated with the lift member and positioned between the actuator and the pivot member.

4. The post extracting apparatus of claim 3, wherein the housing is formed of a material selected from the group consisting of: metal, metal alloy, hardened wood, plastic, and combinations thereof, and further comprises at least three legs.

5. The post extracting apparatus of claim 3, wherein the lift member is a threaded rod and the actuator is a coupling having reciprocal threads.

6. The post extracting apparatus of claim 5, wherein the bearing is a flat roller bearing and the pivot member has a generally top flat surface blended into a generally bored-semi-sphere body.

7. The post extracting apparatus of claim 6, wherein the nut comprises an integral washer and tubular collar adaptable to be received by the generally top flat surface of the pivot member.

8. The post extracting apparatus of claim 4, wherein the legs of the housing are each independently foldable about respective leg pivots.

9. The post extracting apparatus of claim 2, wherein the attachment member is a lag bolt.

10. The post extracting apparatus of claim 2, wherein the attachment member is a wire rope choker.

11. The post extracting apparatus of claim 9, wherein the lag bolt is affixed to a chain and the chain is affixed to one or more clevises, wherein the clevis is affixed to the first end of the lift member.

12. The post extracting apparatus of claim 10, wherein the wire rope choker is affixed to a clevis, wherein the clevis is affixed to the first end of the lift member.

13. The post extracting apparatus of claim 4, wherein adjacent legs of the housing are affixed to each other by a respective brace.

14. The post extracting apparatus of claim 13, wherein the respective braces are each leg chains.

15. A method of removing a buried post from a buried position comprising:
providing proximate to the buried post a post extracting apparatus comprising:
a housing having a bore therethrough, wherein the bore has a shoulder;
a lift member adapted to receive an attachment member at a first end of the lift member, the lift member is disposed in the bore and operatively associated with an actuator, the actuator is operatively associated with a pivot member disposed between the actuator and the housing, the pivot member engaged with at least a portion of the shoulder, wherein actuation of the actuator causes the lift member and the attachment member to move in a first direction;
securing the attachment member to the buried post;
utilizing the actuator to move the lift member, attachment member, and buried post in at least a first direction a distance sufficient to remove the buried post from the buried position.

16. The method of claim 15, wherein the post extracting apparatus is positioned above the buried post, the attachment member is a lag bolt, and the lag bolt is screwed into the buried post at an angle from about 1 degree to about 10 degrees off vertical.

17. The method of claim 15, wherein the post extracting apparatus is positioned above the buried post and the attachment member is a wire rope choker.

18. The method of claim 15, wherein the post extracting apparatus is positioned next to the buried post.

19. The method of claim 15, wherein the post extracting apparatus is positioned concentric with a center of the buried post, the attachment member is a lag bolt, and the lag bolt is screwed into the buried post at an angle from about 1 degree to about 10 degrees off vertical.

20. The method of claim 16, wherein the post extracting apparatus is positioned concentric with a center of the buried post, the attachment member is a wire rope choker.
